(19) United States
(12) Patent Application Publication
(10) Pub. No.: US 2010/0073288 A1
(43) Pub. Date: Mar. 25, 2010

(54) CONTROL ELEMENT FOR A MOTOR VEHICLE

(75) Inventor: Andreas Kramlich, Schweinfurt (DE)

Correspondence Address: CANTOR COLBURN, LLP, 20 Church Street, 22nd Floor, Hartford, CT, 06103, US

(73) Assignee: PREH GMBH, Bad Neustadt a.d. Saale (DE)

(21) Appl. No.: 12/531,612

(22) PCT Filed: Mar. 17, 2008
(86) PCT No.: PCT/EP2008/002113

§ 371 Date: Nov. 10, 2009

(30) Foreign Application Priority Data
Mar. 17, 2007 (DE) 10 2007 012 852.7

(51) Int. Cl. G09G 5/08

(52) U.S. Cl. 345/157

(57) ABSTRACT

An input device including a control surface and a control element that can be moved over the control surface, with means for detecting the position and/or movement of the control element on the control surface and an evaluation unit for generating a control signal corresponding to the detected quantity, where the control element adheringly rests against the control surface by a magnetic force.

### TECHNICAL FIELD

The invention relates to an improved input device for a motor vehicle comprising a control surface and a control element that can be moved over the control surface, with means for detecting the position and/or movement of the control element on the control surface and an evaluation unit for generating a control signal corresponding to the detected quantity.

### BACKGROUND

It is known to use a so-called touchpad as an input device. In a touchpad, input takes place by means of a touch-sensitive control surface, wherein the local change in capacitance or resistance caused by a finger is detected in order thus to obtain position and/or motion data, to then evaluate them by means of an evaluation unit and output them as control signals, for example to an associated display device. Such touchpads are in fact used in cars, however, their operation is perceived as being unsuitable not least because of the lack of haptic feedback. Operation is susceptible to error because the driver does not have the opportunity, most of the time, to concentrate on the input, so that the contact pressure of the finger is insufficient or not consistent. The necessity of having to concentrate on the input is perceived as bothersome by most drivers and may constitute a safety risk.

When a computer is used, the so-called mouse is preferred as an input device over the touchpad built into portable computers. The use of a mouse as an input device in the vehicle could hitherto not be realized because of the high level of jarring and transverse acceleration. Therefore, an input device is desired which is easy to operate and which can be used even given a comparatively high level of jarring and transverse acceleration as it occurs in vehicles, for example.

### BRIEF DESCRIPTION

A control element is provided adheringly resting against the control surface by means of a magnetic force.

The disclosure provides an input device comprising a control surface and a control element that can be moved over the control surface. The invention is not limited with regard to the control element, and options include many bodies, which advantageously are formed in an ergonomic manner. It may, for example, be a rotationally symmetrical body similar to a rotary button. Preferably, the body is designed to be small in order to obtain as small a contact surface as possible on the control surface for a good resolution of the position recognition system. Furthermore, the handling surface is thus reduced in order to render it more difficult to remove the control element from the control surface.

Means for detecting the position and/or movement of the control element on the control surface are provided. An evaluation unit serves for generating a control signal corresponding to the detected quantity. In one embodiment, the means for detecting the position and/or movement and the evaluation unit are integrated into the control element, and the structure of the control element in this regard corresponds, for example, to the structure of a mechanical or optical mouse. The control signal is used, for example, for controlling, that means moving, a cursor on a display device, in accordance with a movement of the control element. However, other applications of the control signal, for example, a music player, are conceivable. The input device according to the invention is characterized in that the control element adheringly rests against the control surface by means of a magnetic force. It is thereby accomplished that the control element still adheres to the control surface despite the jarring and transverse accelerations acting on it, that is, forces parallel to the control surface. Thus, the input device can be used for example with an inclined control surface or if the control surface is moving, for example in a motor vehicle. It is the task of the person skilled in the art to select the optimum adhesive action for the respective application by specifying the magnetic force in combination with the static friction between the control element and the control surface. Generally, a force is chosen which, apart from the aforementioned effect, still permits a comparatively smooth operation. An optimal state can be determined by a few tests.

Preferably, the position and/or movement of the control element is detected optically (by means of infrared light barriers, for example), capacitively, resistively (FSR™ sheet) or inductively. The pertinent technologies are known, inter alia, from touchpads, and can be readily transferred to the apparatus of the invention.

Preferably, the contact pressure generated by the magnetic force is not only used for the adhesive action, but also for position and/or movement recognition. For instance, the input surface is provided on the side facing the operator with a so-called touch-sensitive layer or foil, which, for example, changes its capacitance or resistance locally under the influence of the contact pressure, thus making a recognition of the position possible.

In a preferred embodiment, the magnetic force is generated by a magnet, more preferably permanent magnet, associated with the control element, and a ferromagnetic control surface or a counter magnet associated with the control surface. The invention can thus be realized easily and inexpensively.

In an advantageous embodiment, the position and/or movement is detected by means of a tappet magnetically coupled with the control element. That is, the tappet follows the movement of the input element because of the magnetic coupling. Thus, the comparatively sensitive means for position and/or movement detection can be disposed so as to be protected on the side of the control surface facing away from the operator, protected by said control surface from dust, damage and cleaning liquids. For example, the touch-sensitive layer, upon which the tappet acts in the above-mentioned case, is located on the surface of the control surface facing away from the operator.

In another advantageous embodiment, the control element is provided with at least one actuatable switch, the switching status of which is transmitted to the evaluation unit by radio or infrared. For example, a selection is thereby confirmed. Preferably, the control element is inductively supplied with power, for example by an electromagnetic alternating field being generated in the area of the input pad. For example, a passive transponder is used. Passive RFID technology is used in another embodiment. In this case, the respectively transmitted transponder identification can be used to positively identify an associated control element.

The input device according to the invention is preferably used in a motor vehicle. Thus, the driver is able to use a “mouse”-like input device that is easy for him to operate and demands little attention from him, despite the jarring and transverse acceleration that occurs while driving. As a rule, the driver is very much acquainted with handling such a device, so that no familiarization phase that would be a safety risk would be required.

Furthermore, the invention relates to a household appliance comprising an input device in one of the advantageous embodiments described above. For example, the input device according to the invention can advantageously also be installed where an inclined or also vertical installation of the control surface is required, whereby, at the same time, the operator is offered a comfortable and familiar, “mouse”-like inputting option by the input device while the drawbacks of the mere touchpad are being avoided.

### DESCRIPTION OF THE DRAWINGS

Three different embodiments of the input device according to the invention are shown the accompanying figures, without limiting the invention thereto, wherein

FIG. 1 shows a schematic cross-sectional view of a first embodiment,

FIG. 2 shows a schematic cross-sectional view of a second embodiment, and

FIG. 3 shows a schematic cross-sectional view of a third embodiment.

### DETAILED DESCRIPTION

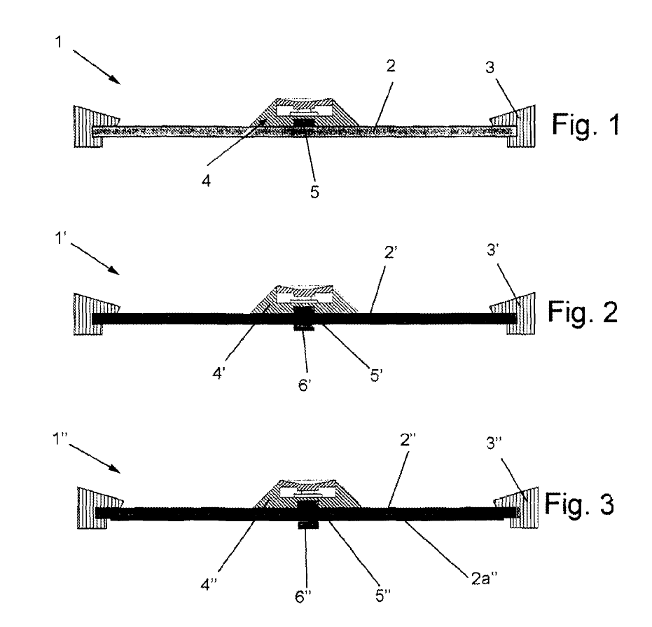

FIG. 1 shows a first embodiment of the input device 1 according to the invention. A ferromagnetic control surface 2 is mounted in a frame 3. A control element 4 is disposed on the control surface 2. Its manual operation, that is, displacement, on the control surface 2 is detected for example by means of a plurality of light barriers integrated in the frame 3 and converted into a control signal corresponding to the movement by means of an evaluation unit which is not shown. In cooperation with the ferromagnetic control surface 2, a permanent magnet integrated into the control element 4 generates a magnetic adhesive force which ensures that the control element 4 does not fall off the control surface 2 even in the case of a transverse acceleration or inclined position of the control surface 2.

FIG. 2 shows a second embodiment of the input device 1′ according to the invention. A non-magnetic control surface 2′ is mounted in a frame 3′. A control element 4′ is disposed on the control surface 2′. In cooperation with a magnetic tappet 6′, which is also a permanent magnet and which is disposed on the side of the control surface 2′ facing away from the operator, a permanent magnet integrated into the control element 4′ generates a magnetic adhesive force which ensures that the control element 4′ does not fall off the control surface 2′ even in the case of a transverse acceleration or inclined position of the control surface 2′. In this embodiment, the manual operation, that is, displacement, of the control element 4′ on the control surface 2′ is detected by means of the tappet 6′. For example, its movement is detected by means of light barriers and converted into a control signal corresponding to the movement by means of an evaluation unit which is not shown. The means for detecting the position or movement, respectively, of the control element 4′ or of its tappet 6′, respectively, are disposed on a side of the input device 1′ protected by the control surface.

FIG. 3 shows a third embodiment of the input device 1″ according to the invention. A non-magnetic control surface 2″ is mounted in a frame 3″. A control element 4″ is disposed on the control surface 2″. In cooperation with a magnetic tappet 6″, which is also a permanent magnet and which is disposed on the side of the control surface 2″ facing away from the operator, a permanent magnet integrated into the control element 4″ generates a magnetic adhesive force which ensures that the control element 4″ does not fall off the control surface 2″ even in the case of a transverse acceleration or inclined position of the control surface 2″. In this embodiment, the manual operation, that is, displacement, of the control element 4″ on the control surface 2″ is detected by means of the tappet 6′ and a touch-sensitive foil 2a″, which for example is resistive or capacitive and attached on a side of the control surface 2″ facing away from the operator. The foil 2a″ for detecting the position or movement, respectively, of the control element 4″ or of its tappet 6″, respectively, are disposed on a side of the input device 1″ protected by the control surface.

1. Input device, comprising:
a control surface;
a control element that can be moved over the control surface;
means for detecting the position and/or movement of the control element on the control surface; and
an evaluation unit for generating a control signal corresponding to the detected quantity,
wherein the control element adheringly rests against the control surface a magnetic force.

2. Input device according to claim 1, wherein the position and/or movement of the control element is detected optically, capacitively, resistively and/or inductively.

3. Input device according to claim 2, wherein contact pressure generated by the magnetic force is used for the position and/or movement recognition of the control element.

4. Input device according to claim 3, wherein the magnetic force is generated by a magnet associated with the control element and a ferromagnetic control surface and/or a counter magnet associated with the control surface.

5. Input device according to claim 1, wherein the position and/or movement is detected by a tappet magnetically coupled with the control element.

6. Input device according to claim 1, wherein the control element is provided with at least one actuatable switch, a switching status of which is transmitted to the evaluation unit via radio or infrared.

7. Input device according to claim 1, wherein the control element is inductively supplied with power.

8. Motor vehicle, comprising an input device according to claim 1.

9. Household appliance, comprising an input device according to claim 1.
